(19) United States
(12) Patent Application Publication
(10) Pub. No.: US 2012/0087025 A1
(43) Pub. Date: Apr. 12, 2012

(54) HYBRID EXTERIOR REAR VIEW MIRROR ASSEMBLY

(75) Inventors: Peter Hein, Denkendorf (DE); Gregor Serve, Backnang (DE)

(73) Assignee: SMR Patents S.a.r.l., Luxembourg (LU)

(21) Appl. No.: 13/240,342

(22) Filed: Sep. 22, 2011

(30) Foreign Application Priority Data
Oct. 11, 2010 (EP) 10187090

(51) Int. Cl. B60R 1/074

(52) U.S. Cl. 359/841

(57) ABSTRACT

A hybrid exterior rear view mirror assembly for motor vehicles is described, including a mirror base and an exterior rear view mirror. The mirror base and the exterior rear view mirror are hinged together, so that the exterior rear view mirror can be pivoted about a hinge axis in relation to the mirror base from an operating position into a folding position and vice versa. The hybrid exterior rear view mirror assembly allows the provision of either hand-operated or electromotively operated pivoting of the exterior rear view mirror about the hinge axis in relation to the mirror base, by using one and the same mirror base. For this purpose, the mirror base comprises means for acceptance, optionally, of an axis forming the hinge axis, or of a pivot drive including the hinge axis, whereby the axis is provided for hand-operated pivoting and the pivot drive is provided for electromotively operated pivoting.

The invention is based on a priority patent application EP 10187090.5 which is hereby incorporated by reference.

### BACKGROUND ART

1. Field of the Invention

The invention relates to a hybrid exterior rear view mirror assembly for motor vehicles including a mirror base and an exterior rear view mirror, whereby: the mirror base and the exterior rear view mirror are hinged together, so that the exterior rear view mirror can be pivoted about a hinge axis in relation to the mirror base from an operating position into a folding position and vice versa, and the hybrid exterior rear view mirror assembly allows the provision of either hand-operated or electromotively operated pivoting of the exterior rear view mirror about the hinge axis in relation to the mirror base, by using one and the same mirror base, wherein the mirror base comprising means for optional acceptance of an axis forming the hinge axis, or of a pivot drive including the hinge axis, whereby the axis is provided for hand-operated pivoting and the pivot drive is provided for electromotively operated pivoting.

2. Description of the Related Art

An exterior rear view mirror assembly for a motor vehicle consists, for example, of a mirror base arranged on the motor vehicle, which can be covered by means of a mirror base cover, and an exterior rear view mirror arranged on the mirror base. The exterior rear view mirror includes an exterior rear view mirror housing, which, inter alia, houses the base bracket assigned to the mirror base.

The mirror base and the base bracket are hinged together, so that the exterior rear view mirror can be pivoted about a hinge axis in relation to the mirror base from an operating position into a folding position and vice versa. The mirror base and base bracket can be produced from die-casting material, for example, from the same material.

The articulated connection primarily consists of a pin forming the hinge axis and each joint socket surrounding the pin on the mirror base and on the base bracket. On one side, the pin is integrally connected to the mirror base or to the base bracket, and stands centrally on the joint socket of the mirror base or the base bracket. On the joint socket of the respective opposite-facing component, a bearing opening is provided in the centre for the free end of the pin. The bearing opening forms an entrance for a bearing bush assigned to the pin, or forms a bearing bush itself, which guides the pin.

Pivoting the exterior rear view mirror in relation to the mirror base, about the hinge axis, from an operating position into a folding position and vice versa, can be done by hand, or electromotively, according to the fittings of the vehicle. It may transpire, for example, that hand-operated pivoting is provided in a first exterior rear view mirror assembly for a first motor vehicle, and electromotively operated pivoting is provided in a second motor vehicle of the same series as the first motor vehicle.

Independently of whether a hand-operated or electromotively operated pivoting is provided, folding of the exterior rear view mirror must be ensured in the case of external force effect. Here, the folding can take place both in, as well as contrary to, the direction of movement of the vehicle. An external force effect can be caused, for example, by contact with another road user or with an object.

In order to keep an exterior rear view mirror in an operating position in relation to a mirror base, whilst at the same time ensuring folding in the case of an external force effect, an exterior rear view mirror assembly for a motor vehicle with a locking body is known in EP 0 551 607 A1. The exterior rear view mirror assembly includes an exterior rear view mirror, which is arranged so that it can be pivoted about a hinge axis on a mirror base. The axis of a tubular rivet, which connects the mirror base to the exterior rear view mirror, forms the hinge axis. A locking body, permeated by the tubular rivet, is trapped between the mirror base and the exterior rear view mirror. The locking body is part of a detachable catch mechanism, which can be overcome by an external force effect, which keeps the exterior rear view mirror at least in the operating position. The catch mechanism consists of detachable interlocking catch mechanism elements on a front side of the locking body, as well as on the adjacent part of the mirror base or the exterior rear view mirror. The locking body is loaded with a spring, acting axially in the direction of the catch mechanism element operation. The spring can be trapped in the tubular rivet.

For realisation of hand-operated or electromotively operated pivoting of the exterior rear view mirror about the hinge axis in relation to the mirror base, to date, with the exception of some special solutions, differently designed mirror bases and base brackets are provided, which is connected to high development effort, assembly effort and expenditure. Additionally, this therefore results in a corresponding danger of confusion of the individual components in assembly, connected to expensive and time-consuming rework.

In WO 2009/035931, a special solution of this type is known in the form of a hybrid exterior rear view mirror assembly for a motor vehicle, with an exterior rear view mirror arranged on the mirror base by means of a base bracket. The mirror base and the base bracket are hinged together, so that the exterior rear view mirror can be pivoted about a hinge axis in relation to the mirror base from an operating position into a folding position and vice versa. The mirror base has a joint socket, in whose centre a fixed, non-rotatable pin, which is integrally connected to the mirror base, is arranged, which forms the hinge axis. The base bracket housed in an exterior rear view mirror housing also has a joint socket, in whose centre a bearing opening is arranged, which is assigned to the pin. The hybrid exterior rear view mirror assembly is therefore characterized in that, by using one and the same mirror base and one and the same base bracket, either hand-operated or an electromotively operated pivoting about the hinge axis can be provided. For this purpose, the exterior rear view mirror assembly is basically designed for hand-operated pivoting, into which exterior rear view mirror assembly an electric motor can be integrated, which, by means of a reduction gear, acts on a gear rim on an adjacent part of the mirror base or the exterior rear view mirror. On the joint socket of the base bracket, recesses are arranged around the bearing opening, which correspond to protrusions of a gear rim, which can optionally be installed between the joint sockets of the base bracket and mirror base. Due to the corresponding recesses and protrusions, the gear rim, which is trapped between the joint sockets of the mirror base and the base bracket, is non-rotatable in relation to the base bracket. A pinion of the electric motor, which can optionally be arranged on the mirror base, engages in the teeth of the gear rim, so that the base bracket can be electromotively pivoted by the electric motor in relation to the mirror base. An exclusively hand-operated pivoting of the base bracket in relation to the mirror base is realised by omission of the gear rim and electric motor.

The disadvantage of this is the complicated production of the mirror base and the base bracket, in which the electric motor, the gear rim, as well as, if necessary, a reduction gear, must be able to be integrated. In addition, the electric motor must apply high torque, in order to overcome at least one screening, which keeps the exterior rear view mirror at least in the operating position in hand-operated pivoting, which is provided in principle.

A pivot drive for an exterior rear view assembly of a motor vehicle is known in EP 1 755 923 B1. The pivot drive includes a first part, which is pivotably connected to a second part about a hinge axis. In addition, the pivot drive includes an electric drive for electromotively activated pivoting of the parts in relation to one another. The pivot drive also comprises a coupling between the first and second part. In the case of an external force effect, the coupling cancels a torque-locking linking of the electric drive with both parts, required for electromotively activated pivoting of both parts relative to one another, so that both parts can be pivoted by hand. In the case of renewed electromotive drive, the coupling restores the torque-locking linking, so that both parts can again be electromotively pivoted. The coupling thus ensures folding of an exterior rear view mirror in and contrary to the direction of movement of the motor vehicle by an external force effect, without damaging the electric drive.

An aim in the development and production of motor vehicle parts, such as perhaps an exterior rear view mirror assembly, optionally with hand-operated or electromotively operated pivoting of the exterior rear view mirror about the hinge axis in relation to the mirror base, is a simple, time-saving, and cost-effective production and assembly.

Exterior rear view mirror assemblies or exterior rear view mirrors with a variety of different components according to the type of design, such as e.g. different mirror bases and/or base brackets for hand-operated or electromotively operated pivoting, are contrary to this aim.

### SUMMARY OF THE INVENTION

An object of the invention is to create an improved exterior rear view mirror assembly for motor vehicles, which with optional realisation of hand-operated or electromotively operated pivoting of the exterior rear view mirror about the hinge axis in relation to the mirror base, permits a simple and cost-effective production and assembly.

The object is achieved by the following features:

the mirror base and the exterior rear view mirror are hinged together, so that the exterior rear view mirror can be pivoted about a hinge axis in relation to the mirror base from an operating position into a folding position and vice versa, and

the hybrid exterior rear view mirror assembly allows the provision of either hand-operated or electromotively operated pivoting of the exterior rear view mirror about the hinge axis in relation to the mirror base, by using one and the same mirror base,

wherein the mirror base comprising means for optional acceptance of an axis forming the hinge axis, or of a pivot drive including the hinge axis, whereby the axis is provided for hand-operated pivoting and the pivot drive is provided for electromotively operated pivoting.

Accordingly, a hybrid exterior rear view mirror assembly for motor vehicles is provided, which includes a mirror base and an exterior rear view mirror. The mirror base is provided for attachment to the motor vehicle. The exterior rear view mirror is arranged so that it can be pivoted about a hinge axis on a mirror base. For this, the mirror base and the base bracket are hinged together, so that the exterior rear view mirror can be pivoted about a hinge axis in relation to the mirror base from an operating position into a folding position and vice versa. The exterior rear view mirror can include an exterior rear view mirror housing, which, inter alia, can house a base bracket assigned to the mirror base. The mirror base preferably has a joint socket. Equally, the exterior rear view mirror, for example, its base bracket, preferably has a joint socket assigned to a joint socket of the mirror base. The hinge axis stands vertically on both joint sockets. When using one and the same mirror base, the hybrid exterior rear view mirror assembly permits either

hand-operated or

electromotively operated

pivoting of the exterior rear view mirror about the hinge axis. For this, at least the mirror base comprises means for acceptance, optionally, of an axis forming the hinge axis, or of a pivot drive including the hinge axis. In the process, respectively, the axis for hand-operated pivoting is provided in the case of hand-operated pivoting, and the pivot drive for electromotively operated pivoting is provided in the case of electromotively operated pivoting.

In an initial state, at least the mirror base is here neither principally constructed for hand-operated pivoting, nor principally for electromotively operated pivoting about the hinge axis. The hinge axis is first defined with the selection of the connection of the mirror base and exterior rear view mirror. The selection is made by the choice of hand-operated or electromotively operated pivoting of the mirror base and exterior rear view mirror relative to one another, whereby the corresponding connection to the exterior rear view mirror is selected by means of the axis or by means of the pivot drive. The selection of the connection can also concern, for example, the choice of different base brackets of the exterior rear view mirror.

Determination of the hinge axis firstly with the selection of the connection does not mean, however, that it must concern different positions and spatial positions of the hinge axis, depending on whether hand-operated or electromotively operated pivoting is provided, nor that a limitation exists to that effect, that on selection of the hand-operated pivoting, the hinge axis must be identical to the hinge axis on selection of the electromotively operated pivoting.

In the initial state, in which neither the axis, nor the pivot drive are arranged, the mirror base and the exterior rear view mirror are not connected to each other in a bearing manner. Only the arrangement of the axis or the pivot drive on the mirror base establishes a connection, including the hinge axis, between the mirror base and the exterior rear view mirror. Therefore, hand-operated pivoting is first realised by not using the pivot drive and using the axis, whereas electromotively operated pivoting is realised by not using the axis and using the pivot drive.

The means for optional acceptance of the axis forming the hinge axis on the mirror base preferably include, for example, a central bearing opening, arranged in the joint socket of the mirror base, for the axis. The exterior rear view mirror preferably also comprises a bearing opening for the axis. This bearing opening on the exterior rear view mirror can be provided centrally on a joint socket of the exterior rear view mirror. The axis provided for hand-operated pivoting penetrates both bearing openings on the mirror base and on the exterior rear view mirror. The axis is preferably arranged on the exterior rear view mirror and/or on the mirror base in such a way that it can be pivoted about the hinge axis.

Particularly advantageously, the exterior rear view mirror can comprise a base bracket.

If the exterior rear view mirror comprises a base bracket, in the case of hand-operated pivoting, a first base bracket can be provided, which has means to accept an axis forming a hinge axis. In the case of electromotively operated pivoting, a second base bracket can be provided, which has means to accept a pivot drive including the hinge axis. The first and second base brackets differ here due to the different means for acceptance of the axis or the pivot drive. In the process, the first base bracket and the axis are provided for hand-operated pivoting, and the second base bracket and the pivot drive are provided for electromotively operated pivoting.

Alternatively, it is possible that if the exterior rear view mirror comprises a base bracket, this permits, in exactly the same as the mirror base, by using one and the same base bracket, either

hand-operated or

electromotively operated

pivoting of the exterior rear view mirror about the hinge axis. For this purpose, a mirror base of this type comprises means for acceptance, optionally, of an axis forming the hinge axis, or of a pivot drive including the hinge axis. In the process, the axis for hand-operated pivoting is provided for hand-operated pivoting, and the pivot drive for electromotively operated pivoting is provided for electromotively operated pivoting.

If the exterior rear view mirror comprises a base bracket, the means for acceptance of the axis forming the hinge axis on the base bracket can comprise a central bearing opening arranged in a joint socket provided on the base bracket, for example. The axis provided for hand-operated pivoting penetrates the central bearing opening of the base bracket provided in the joint socket, for example, as well as, preferably, a bearing opening on the mirror base, also centrally provided in a joint socket. The axis therefore penetrates both central bearing openings of the mirror base and base bracket provided in the joint sockets, for example.

The central bearing opening can here be provided for a first base bracket, which is provided as well as the axis, in order to implement hand-operated pivoting, and differs from a second base bracket, which is provided as well as the pivot drive, in order to implement electromotively operated pivoting. Alternatively, the central bearing opening can be provided for a base bracket, which, by using one and the same base bracket, permits either hand-operated or electromotively operated pivoting of the exterior rear view mirror about the hinge axis.

The pivot drive preferably includes a first part, which is pivotably connected about a hinge axis to a second part. In addition, the pivot drive includes an electric drive for electromotively operated pivoting about the hinge axis of the parts in relation to one another. The first part of the pivot drive can be accommodated on the mirror base, the second part on the base bracket.

The means for optional acceptance of the pivot drive including the hinge axis on the mirror base preferably include a recess arranged in the joint socket of the mirror base, with means for fastening at least one section of the pivot drive in the recess. If the exterior rear view mirror includes a base bracket, the joint socket, the at least one recess arranged in the joint socket of the mirror base, as well as the means for fastening at least one section of the pivot drive in the recess, can thus be provided on the base bracket.

The recess, as well as the means for fastening at least one section of the pivot drive in the recess can here be provided for a second base bracket, which is provided as well as the pivot drive, in order to implement electromotively operated pivoting, and which differs from a first base bracket, which is provided as well as an axis, in order to implement hand-operated pivoting. Alternatively, the recess as well as the means for fastening at least one section of the pivot drive in the recess can be provided in a base bracket, which allows the provision of either hand-operated or electromotively operated pivoting of the exterior rear view mirror about the hinge axis, by using one and the same base bracket.

The section of the pivot drive preferably concerns at least a section of a first part of a pivot drive, built as previously described.

The means for fastening at least one section preferably of a first part of the pivot drive in the recess can include a locking connection. A locking connection, also designed as a clip connection or a snap connection, includes corresponding locking elements, of which at least one is elastically deformable, and following a deformation, hooks detachably or inextricably with at least another to produce the locking connection.

Examples of corresponding locking elements of this type are an elastically deformable locking means and a rearward engagement. For example, the locking connection can be produced by inserting the at least one section of the first part of the pivot drive into the related recess, followed by rotating the first part about the hinge axis. Alternatively or additionally, a bolted connection, adhesive connection or otherwise suitable connection can be provided, in order to ensure the locking connection between the first part of the pivot drive and the mirror base, or in order to fasten the first part of the pivot drive to the mirror base.

It is important to emphasise, that if joint sockets are provided on the mirror base and on the exterior rear view mirror, the second part of the pivot drive, fastened on the exterior rear view mirror, can include the joint socket of the exterior rear view mirror assigned to the joint socket of the mirror base.

Particularly if the exterior rear view mirror includes a base bracket, which allows the provision of either hand-operated or electromotively operated pivoting of the exterior rear view mirror about the hinge axis, by using one and the same base bracket, the means for optional acceptance of the pivot drive, including the hinge axis, on the base bracket can preferably include at least one through-opening arranged in a joint socket of the base bracket, for example. A shaft forming the hinge axis of the pivot drive, provided for electromotively operated pivoting, passes though the through-opening through the joint socket of the base bracket. In addition, means for fastening the second part of the pivot drive to the base bracket can be provided on the side of the joint socket of the base bracket, which is turned away from the mirror base. The at least one through-opening provided for the pivot drive can also be provided with a central bearing opening, can include this or can be encompassed by this, which central opening is provided for an axis, which is required for hand-operated pivoting.

In addition, the pivot drive can comprise a coupling between the first and second part. In the case of an external force effect, the coupling cancels a torque-locking linking of the electric drive with both parts, required for electromotively activated pivoting of both parts relative to one another, so that both parts can be pivoted by hand. Cancelling the torque-locking linking of the electric drive and both parts can take place, for example, by the torque-locking linking of the electric drive to one of both parts being cancelled, for example, by means of a friction clutch. In the case of renewed electromotive drive, the coupling restores the torque-locking linking, so that both parts can again be electromotively pivoted. The coupling thus ensures folding of an exterior rear view mirror in and contrary to the direction of movement of the motor vehicle by an external force effect, without damaging the electric drive.

The axis provided for hand-operated pivoting, here forming the hinge axis, can include a tubular rivet.

The tubular rivet can be spring-loaded, for example, if necessary in co-operation with e.g. catch mechanism elements provided on or in the joint sockets, in order to form a catch mechanism, which keeps the exterior rear view mirror at least in the operating position. The spring load can be produced by impact with a spring, acting axially in the direction of the catch mechanism element operation. The spring can be trapped in the tubular rivet.

In addition, the mirror base and/or the exterior rear view mirror can have corresponding stops, which define at least one, however, preferably two, final positions in a pivoting of the exterior rear view mirror in relation to the mirror base. The stops can be provided, for example, on or in joint sockets of the mirror base and the exterior rear view mirror, which are assigned to one another. The joint socket of the exterior rear view mirror can be provided on a base bracket of the exterior rear view mirror, provided if necessary. The final positions preferably correspond to an operating position and a folding position of the exterior rear view mirror, for example, including an exterior rear view mirror housing accommodating a base bracket, in relation to the mirror base. Alternatively, the stops can define a front folding position against the direction of movement, and preferably a rear folding position corresponding to the folding position in the direction of movement.

It is apparent that the invention can also be realised by a hybrid mirror base, which can be provided both for hand-operated pivoting, as well as for electromotively operated pivoting of an exterior rear view mirror arranged thereon, which can be pivoted about a hinge axis, of an exterior rear view mirror assembly. The mirror base to be mounted on the motor vehicle comprises means for optional acceptance of an axis forming the hinge axis, or of a pivot drive including the hinge axis. Preferably, the mirror base to be mounted on the motor vehicle comprises a joint socket, which can comprise the means for optional acceptance of an axis forming the hinge axis, or of a pivot drive including the hinge axis. The means for optional acceptance of the axis here preferably include a central bearing opening for the axis in the joint socket. The means for optional acceptance of the pivot drive, including the hinge axis, on the mirror base preferably include at least one recess arranged in the joint socket of the mirror base, with means for fastening at least one section, for example, of a first part of the pivot drive in the recess. The pivot drive is preferably designed as previously described in detail.

In addition, the mirror base can comprise one or several of the features previously described in detail for the exterior rear view mirror assembly.

Advantages of the invention are given, inter alia, in that for an exterior rear view mirror assembly, which is to be designed optionally with hand-operated or with electromotively operated pivoting, fewer components and above all, those which are cost-effective to produce, are required. Through this:

the development, production and assembly efforts are considerably reduced in comparison to the prior art.

a time-intensive and cost-intensive risk of confusion in assembly is avoided.

the high assembly effort required for special solutions are avoided.

a pivot drive with low torque is required, as provided in special solutions according to the prior art. This is due to the fact that special solutions of this type to date basically provide hand-operated pivoting, and on this basis, realise electromotively operated pivoting by additional installation of an electric motor and a reduction gear. Here, for hand-operated pivoting, a strong catch mechanism is generally provided, which can only be overcome with high expenditure of energy, which also has to be overcome by the electric motor. A pivot drive, provided according to the invention can engage and disengage an internally built screening, if necessary, so that a considerably lower drive moment is required, connected with lower power consumption, lower cable cross-sections, more cost-effective electronic components, and considerably reduced operating noise.

it is made possible to produce the pivot drive independently of the exterior rear view mirror assembly. Through this, the assembly effort is reduced for both the pivot drive and the exterior rear view mirror assembly, into which only the completed pivot drive including the hinge axis must be inserted.

### BRIEF DESCRIPTION OF THE DRAWINGS

Further features of the invention result from the claims, description and drawings.

Execution examples of the invention are subsequently explained in more detail by means of the drawings. Identical reference characters denote identical or identically acting elements. In the drawings, shown schematically:

FIG. 1 shows a view of an exterior rear view mirror assembly from its front side oriented in the direction of movement of a motor vehicle.

FIG. 2 shows a cross-section through an exterior rear view mirror assembly provided for electromotively operated pivoting.

FIG. 3 shows a cross-section through an exterior rear view mirror assembly provided for hand-operated pivoting.

FIG. 4 shows a hybrid mirror base of the exterior rear view mirror assemblies from FIGS. 1 to 3 in a perspective view.

### DETAILED DESCRIPTION OF THE DRAWINGS

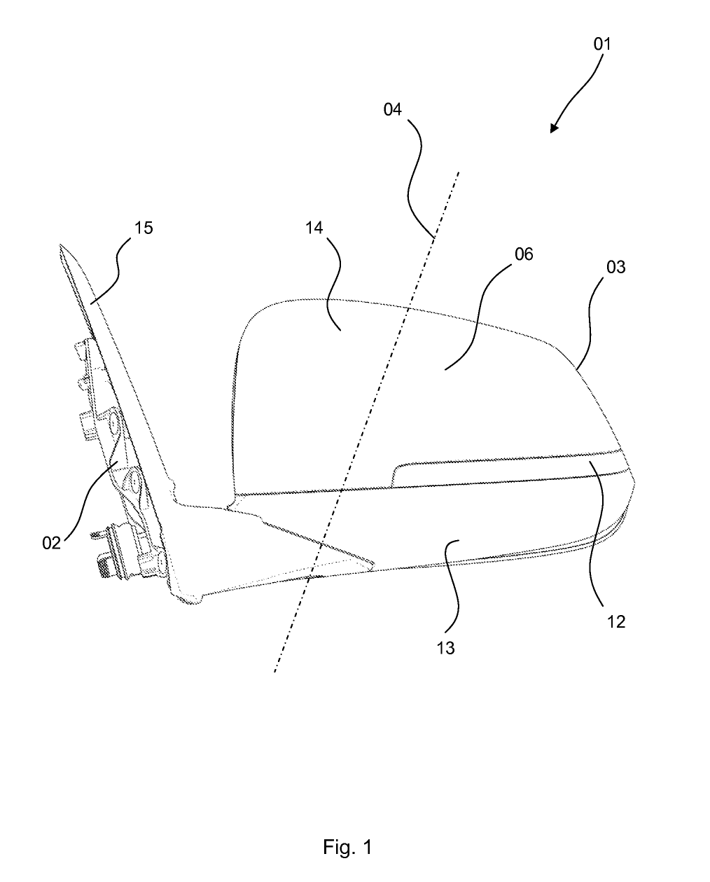

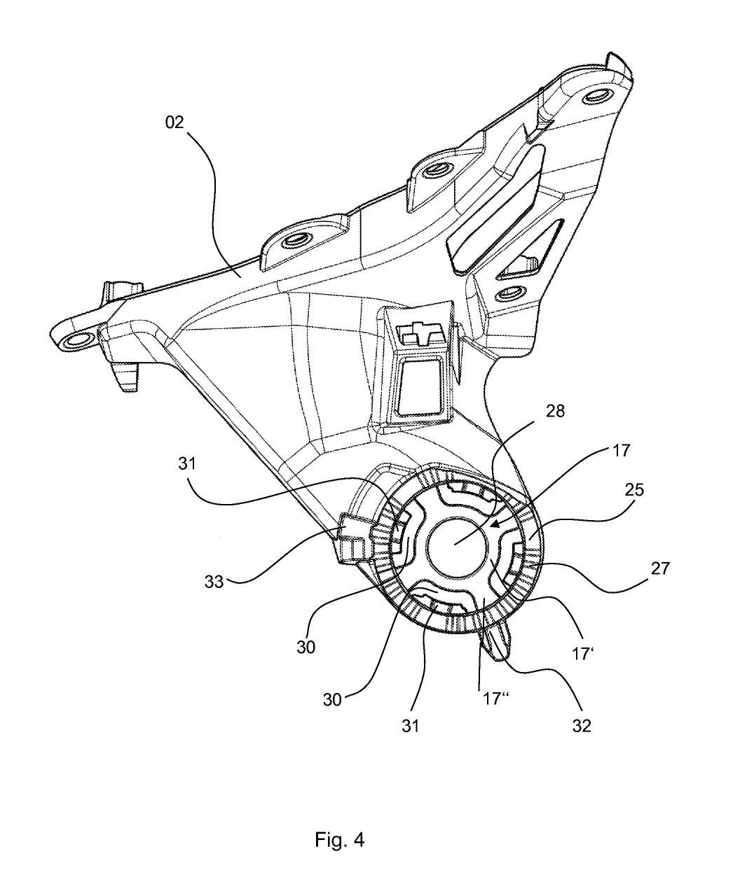

A hybrid exterior rear view mirror assembly 01 for a motor vehicle, fully or partly shown in FIGS. 1 to 3, essentially comprises a hybrid mirror base 02 shown in detail in FIG. 4, and an exterior rear view mirror 03 also denoted as a mirror head.

The mirror base 02 and the exterior rear mirror 03 are connected to each other in an articulated manner. Here, the exterior rear view mirror 03 can be pivoted about a hinge axis 04 in relation to the mirror base 02 from an operating position shown in FIG. 1 into a folding position and vice versa.

The exterior rear view mirror 03 includes a base bracket 05. The base bracket 05 is preferably assigned to the mirror base 02. The exterior rear view mirror 03 also includes an exterior rear view mirror housing 06, which, inter alia, houses the base bracket 05.

An adjusting device, driven by an electric motor, for example, for a mirror glass 07 is arranged on the base bracket 05, provided if necessary. The adjusting device acts on a backing plate 08, on which the mirror glass 07 is arranged. The mirror glass 07 can be mounted onto the backing plate 08 by means of an adhesive connection. The backing plate 08 can be guided to and/or mounted on the adjustment device and/or the base plate 05. The term ‘backing plate’ here refers to any type of bracket, which comprises at least one bracket surface, with a plane or vaulted design, closed or in a non-continuous grid, for example, honeycombed, on which it is suitable to attach a mirror glass 07, for example by means of an adhesive connection or by clipping e.g. locking means, protruding behind the perimeter of the bracket surface and arcing inwards towards the centre of the bracket surface, seen from the perimeter.

On its rear side, facing away from the direction of movement of the vehicle in the operating position, the exterior rear view mirror housing 06 comprises an opening 09, through which the mirror glass 07 is visible, or in which the mirror glass is arranged 07. In order to ensure that the mirror glass 07 is adjustable, a distance is kept on all sides between the mirror glass 07 or backing plate 08 and the walls 10 of the exterior rear view mirror housing 06 surrounding the opening 09, so that a gap 11 is given around the mirror glass 07 between the walls 10 of the exterior rear view mirror housing 06 surrounding the opening 09.

In addition to or instead of an electromotive activation for the adjustment device of the mirror glass 07, the exterior rear view mirror 03 can also accommodate one or several additional electrical components. Examples of electrical components of this type are:

a turn signal indicator 12,

an entry light,

a heatable mirror glass,

an electro-chromatically dimmable mirror glass,

a detection module and/or warning display module for a driving assistance device, such as blind spot monitoring, a lane departure warning, approach monitoring, or similar,

a sensor for detecting driving and/or surrounding conditions, such as for example, temperature, brightness, degree of pollution, lighting situation, for example, in order to automatically heat the mirror glass, or to dim electro-chromatically, for example.

In addition, the exterior rear view mirror 03 can comprise one or several combinations of the electrical components given as examples.

In order to simplify the assembly for example of the electrical components at least partly arranged in the inside of the exterior rear view mirror 03, the exterior rear view mirror housing 06 is designed in at least two parts. A first housing part 13 forms the housing base, for example, and a second housing part 14 forms the housing cover. One of both housing parts comprises the housing section lying around the opening 09 for the mirror glass 07, with the walls 10 surrounding the opening 09.

Alternatively or additionally, a separate frame is provided, which comprises the walls 10 surrounding the opening 09 arranged on the rear side of the exterior rear view mirror housing 06.

In addition, the mirror base 02 is covered by means of a mirror base cover 15. This can be for aesthetic or creative reasons, and/or to reduce air resistance.

The electrical components in the exterior rear view mirror 03 are connected to a power supply on the vehicle side, and/or to a control device on the vehicle side, for example, by means of an electrical connection through the mirror base, for example by a vehicle electrical system and/or a bus system. The electrical connection consists of a cable harness 16 with several cables, for example. The cable harness 16 comprises if necessary, separate plug connections to the respective electrical connection of the electrical components. The connection of the electrical components can take place here individually or in groups. In addition, the cable harness 16 comprises if necessary, at least one electrical plug connection for further electrical contacting on the vehicle side.

The hybrid exterior rear view mirror assembly 01 allows the provision of either hand-operated or electromotively operated pivoting of the exterior rear view mirror 03 about the hinge axis 04 in relation to the mirror base 02, by using one and the same mirror base 02.

For this purpose, the mirror base 02 comprises means 17 for optional acceptance of an axis 18 forming the hinge axis 04, or of a pivot drive 19 including the hinge axis 04. Here, the axis 18 is provided for hand-operated pivoting, and the pivot drive 19 is provided for electromotively operated pivoting.

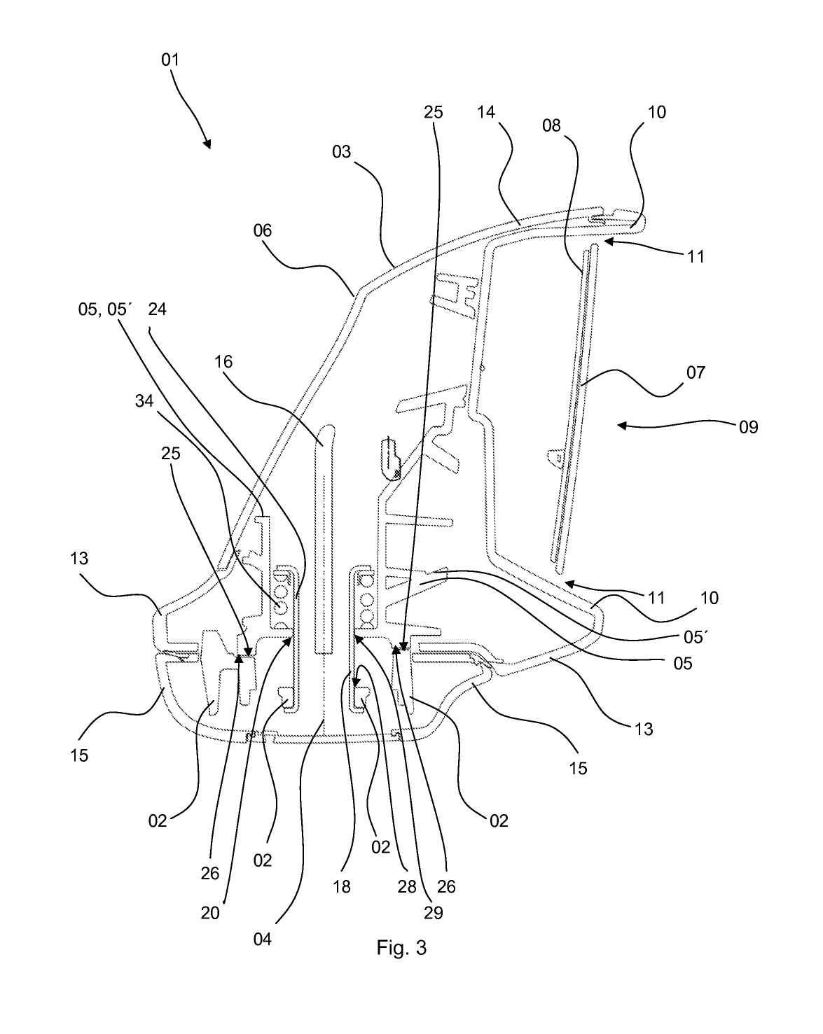

For hand-operated pivoting, a first base bracket 05′ is preferably provided here, which has means 20 to accept an axis 18 forming the hinge axis 04 on the exterior rear view mirror 03 (FIG. 3). In the case of a design with hand-operated pivoting, the axis 18 is at least connected to the mirror base 02 or to the exterior rear view mirror 03 in such a way that it can be rotated about the hinge axis 04.

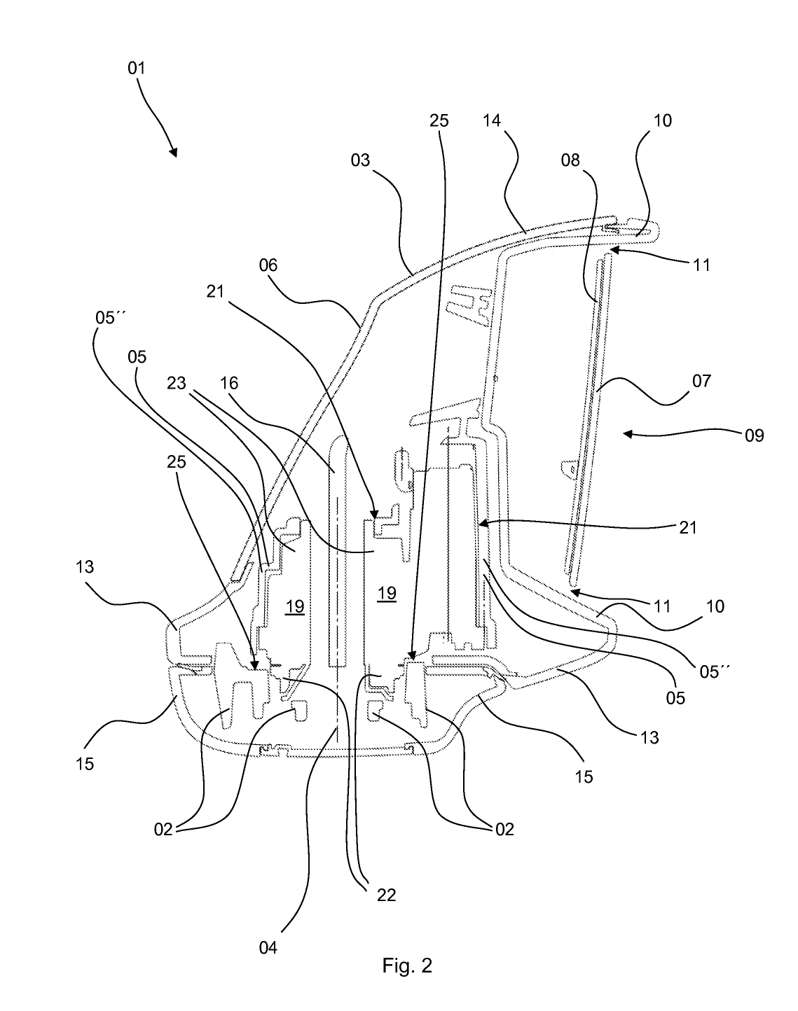

For electromotively operated pivoting, in contrast, a second base bracket 05″ is preferably provided, which has means 21 to accept an axis 19 including the hinge axis 04 on the exterior rear view mirror 03 (FIG. 2). The pivot drive 19 here preferably includes a first part 22 and a second part 23. The first part 22 is pivotably connected about the hinge axis 04 to a second part 23. In addition, the pivot drive 19 includes an electric drive, not shown in more detail, for electromotively operated pivoting about the hinge axis 04 of the parts in relation 22, 23 in relation to one another. If electromotively operated pivoting is provided, the first part 22 of the pivot drive 19 is non-rotatably accepted on the mirror base 02 and the second part 23 is non-rotatably accepted on the exterior rear view mirror 03.

The mirror base 02 is the same for both design variations.

The axis 18 provided for hand-operated pivoting is designed as a tubular rivet 24. A shaft forming the hinge axis 04 of the pivot drive 19, provided for electromotively operated pivoting, is designed as a hollow shaft. Without further constructive changes, these measures permit the cable harness 16 to be passed through the shaft, designed as a hollow shaft, of the pivot drive, or through the axis 18 designed as a tubular rivet 24.

The mirror base 02 has a joint socket 25. Equally, the exterior rear view mirror 03 has a joint socket 26, preferably one for a base bracket 05′ provided for hand operated pivoting. The joint sockets 25, 26 of the mirror base 02 and of the exterior rear view mirror 03 or of the base bracket provided for hand-operated pivoting 05′ are preferably assigned to one another. The hinge axis 04 stands vertically on the joint sockets 25, 26.

The tubular rivet 24 forming the axis 18 provided for hand-operated pivoting is spring-loaded. Spring loading can be provided, if necessary, in co-operation with e.g. catch mechanism elements 27 provided on or in the joint sockets 25, 26, designed as elevations or recesses, for example, in order to form a screening, which at least keeps the exterior rear view mirror 03 in the operating position. The spring load can be produced by impact with a spring 34, acting axially in the direction of the catch mechanism element operation. The spring 34 is trapped in the tubular rivet 24.

At least the joint socket 25 of the mirror base 02 comprises at least one part of the means 17 for acceptance, optionally, of an axis 18 forming the hinge axis 04, or of a pivot drive 19 including the hinge axis 04.

The joint socket 26, for example, of the base bracket 05′ of the exterior rear view mirror 03 provided for hand-operated pivoting, comprises at least one part of the means 20 for acceptance of the axis 18 forming the hinge axis 04 on the exterior rear view mirror 03.

The means 17 for optional acceptance of the axis 18 forming the hinge axis 04 on the mirror base 02 include, for example, a central bearing opening 28, arranged in the joint socket 25 of the mirror base 02, for the axis 18. The means 20 for acceptance of the axis 18 forming the hinge axis 04 on the exterior rear view mirror 03 preferably include a central bearing opening 29 for the axis 18, arranged in the joint socket 26 of the exterior rear view mirror 03, provided on the base bracket 05′ provided for hand-operated pivoting. The axis 18, provided for hand-operated pivoting, permeates both bearing openings 28, 29 in the joint sockets 25, 26 of the mirror base 02, and the base bracket 05′ of the exterior rear view mirror 03 provided for hand-operated pivoting.

The means 17 for optional acceptance of the pivot drive 19 including the hinge axis 04 on the mirror base 02 include a recess 30 arranged in the joint socket 25 of the mirror base 02, with means 31 for fastening at least one section of the pivot drive 19 in the recess 30. The section of the pivot drive 19, which can be fixed in the recess 30, preferably concerns at least one section of the first part 22 of the pivot drive 19. The fastening means 17 forms a star-shaped arrangement in the embodiment of illustration 4, which forms a circular surface 17′ within the joint socket 25 by means of radial arms 17″. Through this, a fastening surface 17′ is created for use of a tubular rivet, whose internal diameter 28 corresponds to the smaller diameter of the tubular rivet. The fastening surface 17′ serves as a bearing for the tubular rivet. It must have sufficient strength and a sufficient radial extension. The extension of the surface 17′ is limited by the requirements on the fastening of the pivot drive.

The pivot drive, in contrast, is fastened to the mirror base with a bayonet catch. For this, protrusions present on the drive or on the backing plate must be pushed through the openings 30 of the means 17 and locked underneath the levels of the means 17 with fastening means 32. The openings 30 of the means 17 must be designed in such a way that the locking device of the drive can be pushed through. According to the drive used, or according to the mirror design, fewer than four openings or more than four openings can also be used. In the process, the means 17 reduce the diameter of the joint socket 25 by at least 50%.

The means 17 are produced with the mirror base in one-piece from the same material, with metal or plastic being used here.

In addition, the mirror base 02 and/or the exterior rear view mirror 03 can have corresponding stops 32, 33, which define at least one, however, preferably two, final positions in pivoting of the exterior rear view mirror 03 in relation to the mirror base 02. The end positions preferably concern a folding or retracting position and a folding or retracting position against the direction of movement of the motor vehicle.

The invention is particularly commercially applicable in the production of exterior rear view mirror assemblies for motor vehicles.

### LIST OF REFERENCE CHARACTERS

01 Hybrid exterior rear view mirror assembly

02 Hybrid mirror base; mirror base

03 Exterior rear view mirror

04 Hinge axis

05, 05′, 05″ Base bracket

06 Exterior rear view mirror housing

07 Mirror glass

08 Backing plate

09 Opening

10 Wall

11 Gap

12 Turn signal indicator

13 First housing part

14 Second housing part

15 Min⁻or base cover

16 Cable harness

17 Means for optional acceptance of an axis forming the hinge axis, or of a pivot drive including the hinge axis on the mirror base

17′ Surface of the means

17″ Arms of the means 17

18 Axis

19 Pivot drive

20 Means for acceptance of an axis forming the hinge axis on the exterior rear view mirror

21 Means for acceptance of a pivot drive including the hinge axis on the exterior rear view mirror

22 First part of the pivot drive

23 Second part of the pivot drive

24 Tubular rivet

25 Joint socket

26 Joint socket

27 Catch mechanism element

28 Bearing opening on the base

29 Bearing opening

30 Recess

31 Means for fastening at least one section of the pivot drive in the recess

32 End stop

33 End stop

34 Spring

1. Hybrid exterior rear view mirror assembly for motor vehicles including a
mirror base and an exterior rear view mirror, whereby:
the mirror base and the exterior rear view mirror are hinged together, so that the exterior rear view mirror can be pivoted about a hinge axis in relation to the mirror base from an operating position into a folding position and vice versa, and
the hybrid exterior rear view mirror assembly allows the provision of either hand-operated or electromotively operated pivoting of the exterior rear view mirror about the hinge axis in relation to the mirror base, by using one and the same mirror base,
wherein
the mirror base comprising means for optional acceptance of an axis forming the hinge axis, or of a pivot drive including the hinge axis, whereby the axis is provided for hand-operated pivoting and the pivot drive is provided for electromotively operated pivoting.

2. Hybrid exterior rear view mirror assembly according to claim 1, characterized in that the exterior rear view mirror includes a base bracket, whereby
for hand-operated pivoting, a first base bracket is provided, which has means to accept an axis forming the hinge axis, and
a second base bracket is provided for electromotively operated pivoting, which has means to accept a pivot drive including the hinge axis.

3. Hybrid exterior rear view mirror assembly according to claim 1, characterized in that the exterior rear view mirror comprises a base bracket, which comprises means for optional acceptance of an axis forming the hinge axis, or of a pivot drive including the hinge axis, whereby the axis is provided for hand-operated pivoting and the pivot drive is provided for electromotively operated pivoting.

4. Hybrid exterior rear view mirror assembly according to claim 1, characterized in that,
in the case of a design with hand-operated pivoting, the axis is connected at least to the mirror base or to the exterior rear view mirror in such a way that it can be rotated about the hinge axis.

5. Hybrid exterior rear view mirror assembly according to claim 1, characterized in that,
the mirror base and the exterior rear view mirror have joint sockets which are assigned to one another, on which the hinge axis stands vertically.

6. Hybrid exterior rear view mirror assembly according to claim 5, characterized in that
the joint socket of the mirror base and/or of the exterior rear view mirror comprise at least one part of the means for optional acceptance of an axis forming the hinge axis, or of a pivot drive including the hinge axis.

7. Hybrid exterior rear view mirror assembly according to claim 5, characterized in that,
the means of optional acceptance of the axis forming the hinge axis on the mirror base include a central bearing opening for the axis, arranged in the joint socket of the mirror base, and the means for acceptance of the axis, forming the hinge axis, on the exterior rear view mirror, include a central bearing opening arranged in the joint socket of the exterior rear view mirror, whereby the axis provided for hand-operated pivoting permeates both bearing openings in the joint sockets of the mirror base and of the exterior rear view mirror.

8. Hybrid exterior rear view mirror assembly according to claim 1, characterized in that,
the pivot drive includes a first part, which is connected to a second part in such a way that it can pivot about the hinge axis, as well as an electric drive for electromotively operated pivoting of the parts in relation to one another about the hinge axis, whereby, when electromotively operated pivoting is provided, the first part of the pivot drive is non-rotatably accommodated on the mirror base and the second part is non-rotatably accommodated on the exterior rear view mirror.

9. Hybrid exterior rear view mirror assembly according to claim 8, characterized in that,
the pivot drive includes a coupling between the first part and the second part, which in the case of external force effect, cancels a torque-locking linking of the electric drive required for electromotively activated pivoting of both parts in relation to one another, and restores the torque-locking linking for renewed electromotive drive.

10. Hybrid exterior rear view mirror assembly according to claim 8, characterized in that,
the second part of the pivot drive accommodated on the exterior rear view mirror includes the joint socket of the exterior rear view mirror assigned to the joint socket of the mirror base.

11. Hybrid exterior rear view mirror assembly according to claim 1, characterized in that,
the means for optional acceptance of the pivot drive including the hinge axis on the mirror base include a recess, arranged in the joint socket of the mirror base, with means for fastening at least one section of the pivot drive in the recess.

12. Hybrid exterior rear view mirror assembly according to claim 11, characterized in that,
the means for fastening at least one section of the pivot drive in the recess include a locking connection, which is preferably produced by introduction of the at least one section into the relevant recess, followed by rotating the section about the hinge axis, and which is preferably ensured by a bolted connection and/or adhesive connection.

13. Hybrid exterior rear view mirror assembly according to claim 1, characterized in that,
the axis provided for hand-operated pivoting, here forming the hinge axis, includes a tubular rivet.

14. Hybrid exterior rear view mirror assembly according to claim 13, characterized in that,
the tubular rivet is spring loaded.

15. Hybrid exterior rear view mirror assembly according to claim 1, characterized in that,
the mirror base and/or the exterior rear view mirror can have corresponding stops, which define at least one final position in pivoting of the exterior rear view mirror in relation to the mirror base.
